(19) United States
(12) Patent Application Publication
(10) Pub. No.: US 2025/0110680 A1
(43) Pub. Date: Apr. 3, 2025

(54) DEVICE INPUT CONTROL BASED ON SPATIAL ALIGNMENT OF DISPLAYS

(71) Applicant: Motorola Mobility LLC, Chicago, IL (US)

(72) Inventors: Amit Kumar Agrawal, Bangalore (IN); Jeffrey T Snow, Barrington, IL (US); Olivier D. Meirhaeghe, Lincolnshire, IL (US)

(73) Assignee: Motorola Mobility LLC, Chicago, IL (US)

(21) Appl. No.: 18/374,344

(22) Filed: Sep. 28, 2023

(51) Int. Cl. G06F 3/14; G06F 3/038

(52) U.S. Cl. CPC G06F 3/1423; G06F 3/038; G06F 2203/0383

(57) ABSTRACT

An electronic device (e.g., a smartphone or tablet) can be connected to another electronic device (e.g., a mobile device such as a laptop or a non-mobile device such as a desktop computer or workstation), allowing the electronic devices to be used together. This connection can be a wired connection or a wireless connection. When the electronic devices are connected, a single input control device (e.g., a trackpad on a laptop or a mouse) can be used to control user input for both devices. Whether a single input control device can be used to control user input for both devices is determined based at least in part on whether the displays of the two electronic devices are spatially aligned, such as whether the displays are positioned at approximately the same angle relative to a surface (e.g., the horizon) and are facing approximately the same direction.

### BACKGROUND

As technology has advanced, our uses for electronic devices have expanded. One such use is small mobile devices, such as smartphones, which have become increasingly powerful despite their small size. These mobile devices provide a great deal of portable processing power but are not without their problems. One such problem is that situations arise in which users desire to use their mobile devices alongside other electronic devices, such as a laptop computer. This can result in the user having to interact with the two devices separately, which can be frustrating for users and lead to user frustration with their devices.

### BRIEF DESCRIPTION OF THE DRAWINGS

Embodiments of device input control based on spatial alignment of displays are described with reference to the following drawings. The same numbers are used throughout the drawings to reference like features and components:

FIG. 1 illustrates an example system implementing the techniques discussed herein.

FIG. 2 illustrates an example architecture implementing the techniques discussed herein.

FIG. 3 illustrates an example of displays that are spatially aligned.

FIG. 4 illustrates an example of displays that are not spatially aligned.

FIG. 5 illustrates an example of the gaze of a user.

FIGS. 6, 7, 8, and 9 illustrate examples of using the techniques discussed herein.

FIG. 10 illustrates an example process for implementing the techniques discussed herein in accordance with one or more embodiments.

FIG. 11 illustrates various components of an example electronic device in which embodiments of device input control based on spatial alignment of displays can be implemented.

### DETAILED DESCRIPTION

Device input control based on spatial alignment of displays is discussed herein. Generally, an electronic device (e.g., a smartphone or tablet) can be connected to another electronic device that is typically a computing device (e.g., a mobile device such as a laptop or a non-mobile device such as a desktop computer or workstation), allowing the electronic devices to be used together. This connection can be a wired connection or a wireless connection. When the electronic device and the computing device are connected, a single input control device (e.g., a trackpad on a laptop or a mouse) can be used to control user input for both devices. Using a same input control device to control user input for multiple devices is also referred to as universal input control.

Whether a single input control device can be used to control user input for both devices is determined based at least in part on whether the displays of the two electronic devices are spatially aligned (also referred to as the two electronic devices being spatially aligned). Two displays are spatially aligned when they are positioned at approximately the same angle relative to a surface (e.g., the horizon) and are facing approximately the same direction. For example, if the displays of a laptop and a smartphone positioned on the surface of a table (or in a stand on the table) are both facing a user and are approximately vertical on the table, then the two displays are spatially aligned. However, if the display of the laptop and the smartphone are facing approximately opposite directions, or if the display of the laptop is approximately vertical on the table and the display of the smartphone is approximately horizontal on the table, then the two displays are not spatially aligned.

In one or more implementations, universal input control for two connected electronic devices is automatically enabled based at least in part on the displays of the two electronic devices being spatially aligned. The universal input control being automatically enabled refers to the universal input control being enabled based at least in part on the displays of the two electronic devices being spatially aligned and connected (e.g., wirelessly or wired). No user input need be provided to enable universal input control, to request that universal input control be enabled, and so forth.

By automatically allowing a single input control device to be used to control input for two electronic devices when the displays of the two electronic devices are spatially aligned, the techniques discussed herein improve the user interface of the one or more electronic devices by automatically enabling single input control in situations in which the user is likely to want to use a single input control device. For example, if the user has two electronic devices connected to one another and positioned next to one another on a table facing the user (e.g., spatially aligned), it is expected that the user will want to use a single input control device to interact with the two electronic devices so a single input control device is automatically allowed to be used to control input for two electronic devices. By way of another example, if the user has two electronic devices connected to one another and positioned next to one another on a table with one facing the user (e.g., approximately vertical) and the other lying flat on the table (e.g., approximately horizontal so not spatially aligned), it is expected that the user will not want to use a single input control device to interact with the two electronic devices so a single input control device is not automatically allowed to be used to control input for two electronic devices.

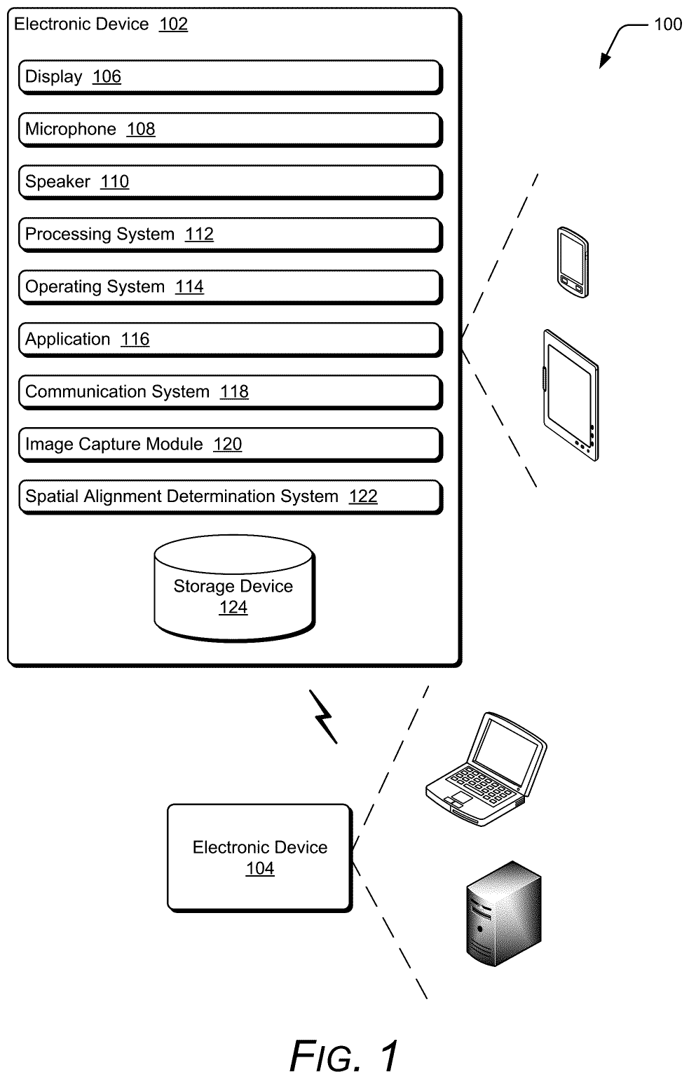

FIG. 1 illustrates an example system 100 implementing the techniques discussed herein. The system 100 includes an electronic device 102 that can be, or include, many different types of computing or electronic devices. For example, the electronic device 102 can be a computing device, such as a smartphone or other wireless phone, a tablet, and so forth. The system 100 also includes an electronic device 104, which can also be many different types of computing or electronic devices but is typically (although need not be) a different type of electronic device than the electronic device 102. For example, the electronic device 102 can be a laptop computer, a desktop computer, an automotive computer, a tablet, and so forth.

In one or more implementations, the electronic device 102 is a touch-enabled device. A touch-enabled device refers to a device that receives touch inputs via the display (e.g., a touchscreen). A touch-enabled device may also receive inputs via other input mechanisms, such as trackpad, mouse, physical keyboard, and so forth. In other implementations, the electronic device 102 is a non-touch-enabled device. A non-touch-enabled device refers to a device that does not receive touch inputs via the display (e.g., a touchscreen). Accordingly, a non-touch-enabled device receives inputs via other input mechanisms, such as trackpad, mouse, physical keyboard, and so forth.

The electronic device 104 can be a touch-enabled device or a non-touch-enabled device.

The electronic device 102 includes a display 106. The display 106 can be configured as any suitable type of display, such as an organic light-emitting diode (OLED) display, active matrix OLED display, liquid crystal display (LCD), in-plane shifting LCD, projector, and so forth. The display 106 can also optionally operate as an input device (e.g., the display 106 can be a touchscreen display).

The electronic device 102 also includes a microphone 108 and a speaker 110. The microphone 108 can be configured as any suitable type of microphone incorporating a transducer that converts sound into an electrical signal, such as a dynamic microphone, a condenser microphone, a piezoelectric microphone, and so forth. The speaker 110 can be configured as any suitable type of speaker incorporating a transducer that converts an electrical signal into sound, such as a dynamic loudspeaker using a diaphragm, a piezoelectric speaker, non-diaphragm based speakers, and so forth.

Although illustrated as part of the electronic device 102, it should be noted that one or more of the display 106, the microphone 108 and the speaker 110 can be implemented separately from the electronic device 102. In such situations, the electronic device 102 can communicate with the microphone 108 or the speaker 110 via any of a variety of wired (e.g., Universal Serial Bus (USB), USB-C, IEEE 1394, High-Definition Multimedia Interface (HDMI)) or wireless (e.g., Wi-Fi, Bluetooth, infrared (IR)) connections. For example, the microphone 108 may be separate from the electronic device 102 and voice inputs received by the microphone 108 are communicated to the electronic device 102 via an IR or radio frequency wireless connection.

The electronic device 102 also includes a processing system 112 that includes one or more processors, each of which can include one or more cores. The processing system 112 is coupled with, and may implement functionalities of, any other components or modules of the electronic device 102 that are described herein. In one or more embodiments, the processing system 112 includes a single processor having a single core. Alternatively, the processing system 112 includes a single processor having multiple cores or multiple processors (each having one or more cores).

The electronic device 102 also includes an operating system 114. The operating system 114 manages hardware, software, and firmware resources in the electronic device 102. The operating system 114 manages one or more applications 116 running on the electronic device 102 and operates as an interface between applications 116 and hardware components of the electronic device 102.

The electronic device 102 also includes a communication system 118. The communication system 118 manages communication with electronic device 104 and optionally various other devices. The electronic device 102 can be coupled to or connected to the electronic device 104 and communicate with the electronic device 104 using any of a variety of wired or wireless connections, such as USB, USB-C, WiFi™, WiFi™ IP (Internet Protocol), USB IP, Bluetooth™, DisplayPort, High-Definition Multimedia Interface (HDMI), and so forth. Typically, the electronic device 102 is removably connected to the electronic device 104, allowing the electronic device 104 to be connected to the electronic device 104 and subsequently disconnected from the electronic device 104.

The electronic device 102 also includes an image capture module 120. The image capture module 120 captures images digitally using any of a variety of different technologies, such as a charge-coupled device (CCD) sensor, a complementary metal-oxide-semiconductor (CMOS) sensor, combinations thereof, and so forth. The image capture module 120 can include a single sensor and lens, or alternatively multiple sensors or multiple lenses. For example, the image capture module 120 may have at least one lens and sensor positioned to capture images from the front of the electronic device 102 (e.g., the same surface as the display is positioned on), and at least one additional lens and sensor positioned to capture images from the back of the electronic device 102. The image capture module 120 can capture still images as well as video.

The electronic device 102 also includes a spatial alignment determination system 122 that automatically determines whether the display 106 and a display of the electronic device 104 are spatially aligned. The two displays are spatially aligned (also referred to as the electronic devices 102 and 104 being spatially aligned) when the two displays are positioned at approximately the same angle relative to a surface (e.g., the horizon) and are facing approximately the same direction.

The spatial alignment determination system 122 can be implemented in a variety of different manners. For example, the spatial alignment determination system 122 can be implemented as multiple instructions stored on computer-readable storage media and that can be executed by the processing system 112. Additionally or alternatively, the spatial alignment determination system 122 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The electronic device 102 also includes a storage device 124. The storage device 124 can be implemented using any of a variety of storage technologies, such as magnetic disk, optical disc, Flash, or other solid state memory, and so forth. The storage device 124 can store various program instructions and data for any one or more of the operating system 114, application 116, and the spatial alignment determination system 122.

In one or more implementations, the electronic device 104 includes components analogous to those discussed above with reference to the electronic device 102, such as a display, a microphone, a speaker, a processing system, an operating system, an application, a communication system, and a storage device. The electronic device 104 may or may not include a spatial alignment determination system.

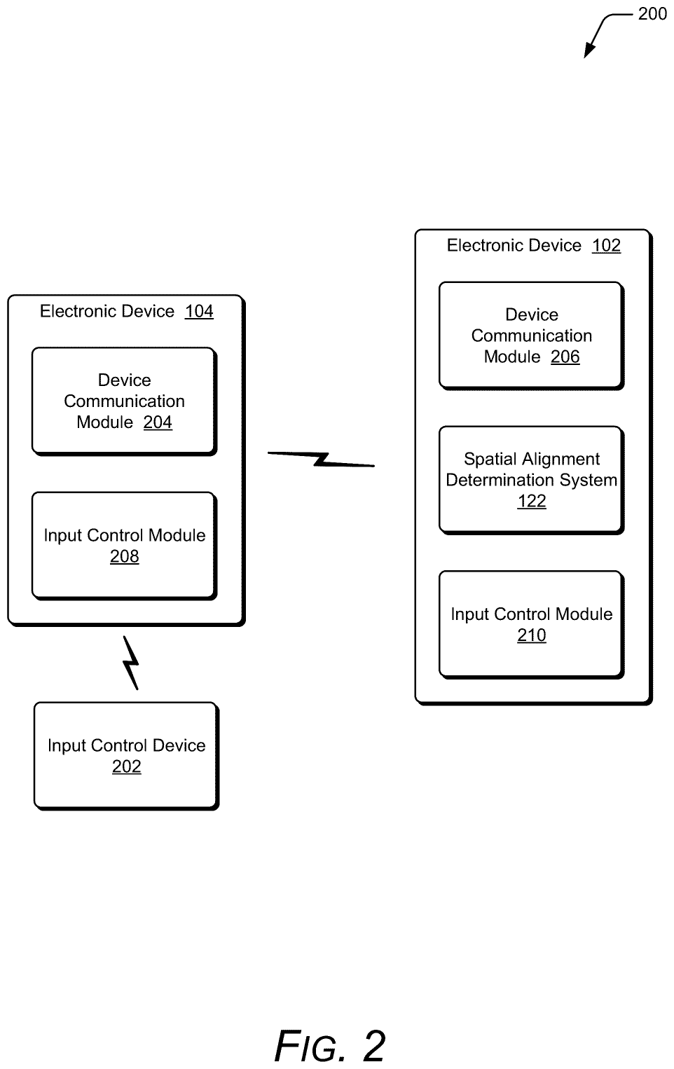

FIG. 2 illustrates an example architecture 200 implementing the techniques discussed herein. The architecture 200 includes the electronic device 102, the electronic device 104, and an input control device 202. The input control device 202, which may also be referred to as a cursor control device or a pointer control device, can be implemented in any of a variety of manners. For example, the input control device 202 may be a mouse, trackpad, keyboard, and so forth. Although illustrated as separate from the electronic device 104, in one or more implementations the input control device 202 is part of the electronic device 104 (e.g., a trackpad of a laptop device).

The electronic device 104 includes a device communication module 204 that implements functionality to detect when the electronic device 104 is connected to the electronic device 102 and to communicate with the electronic device 102 (e.g., send and receive various signals, data, and so forth). Similarly, the electronic device 102 includes a device communication module 206 that implements functionality to detect when the electronic device 102 is connected to the electronic device 104 and to communicate with the electronic device 104 (e.g., send and receive various signals, data, and so forth).

The device communication module 204 can detect that the electronic device 104 is connected to the electronic device 102 (and similarly the device communication module 206 can detect that the electronic device 102 is connected to the electronic device 104) using any of a variety of public or proprietary techniques. For example, the device communication module 204 can transmit a signal that is received by the device communication module 206 indicating that the electronic device 104 is connected to the electronic device 102.

The spatial alignment determination system 122 determines whether a display of the electronic device 104 and a display of the electronic device 102 are spatially aligned. In one or more implementations, the spatial alignment determination system 122 makes this determination based on whether the two displays are positioned at approximately the same angle relative (e.g., relative to a surface, such as the horizon) and are facing approximately the same direction. For example, the spatial alignment determination system 122 determines that the two displays are spatially aligned if the two displays are positioned at approximately the same angle relative to a surface (e.g., the horizon) and are facing approximately the same direction.

The spatial alignment determination system 122 determines whether the two displays are positioned at approximately the same angle relative to a surface in any of a variety of different manners. In one or more implementations, the display of the electronic device 102 includes one or more sensors that determine an angle of the display of the electronic device 102 relative to a surface (e.g., relative to the horizon), such as one or more of a gyroscope, an accelerometer, or a magnetometer (e.g., all of which may be included in an inertial measurement unit (IMU)), and so forth. Additionally or alternatively, the electronic device 102 includes one or more sensors that determine an angle of the display of the electronic device 102 relative to another portion of the electronic device and uses that angle as the angle of the display of the electronic device 102 relative to a surface. For example, if the electronic device 102 is a laptop computer, sensors in the electronic device 102 determine the angle of the display relative to the housing or keyboard of the laptop, and that angle is used as the angle of the display of the electronic device 102 relative to a surface.

In one or more implementations, the electronic device 104 also determines an angle of the display of the electronic device 104 relative to the surface (e.g., a same surface as the spatial alignment determination system 122 uses in determining the angle of the display of the electronic device 102). The electronic device 104 determines the angle of the display of the electronic device 104 relative to the surface in any of a variety of different manners, e.g., analogous to any of the manners in which the spatial alignment determination system 122 determines the angle of the display of the electronic device 102 discussed above. The electronic device 104 may determine the angle of the display of the electronic device 104 relative to the surface in the same manner as the spatial alignment determination system 122 determines the angle of the display of the electronic device 102 relative to the surface, or in a different manner. The electronic device 104 transmits an indication of the angle of the display of the electronic device 104 to the electronic device 102.

The spatial alignment determination system 122 determines whether the two displays are positioned at approximately the same angle relative to a surface based on the angle of the display of the electronic device 102 and the angle of the display of the electronic device 104. In one or more implementations, if the angles of the displays of the electronic devices 102 and 104 are approximately the same (e.g., within a threshold number of degrees such as 5 or 10 degrees) then the spatial alignment determination system 122 determines that the two displays are positioned at approximately the same angle relative to a surface. For example, if the display of the electronic device 102 and the display of the electronic device 104 are both approximately vertical (e.g., within a threshold number of degrees of vertical, such as 5 or 10 degrees) or are both approximately horizontal (e.g., within a threshold number of degrees of horizontal, such as 5 or 10 degrees) then the spatial alignment determination system 122 determines that the two displays are positioned at approximately the same angle relative to a surface. The surface used to determine horizontal or vertical can be, for example, the Earth or the horizon.

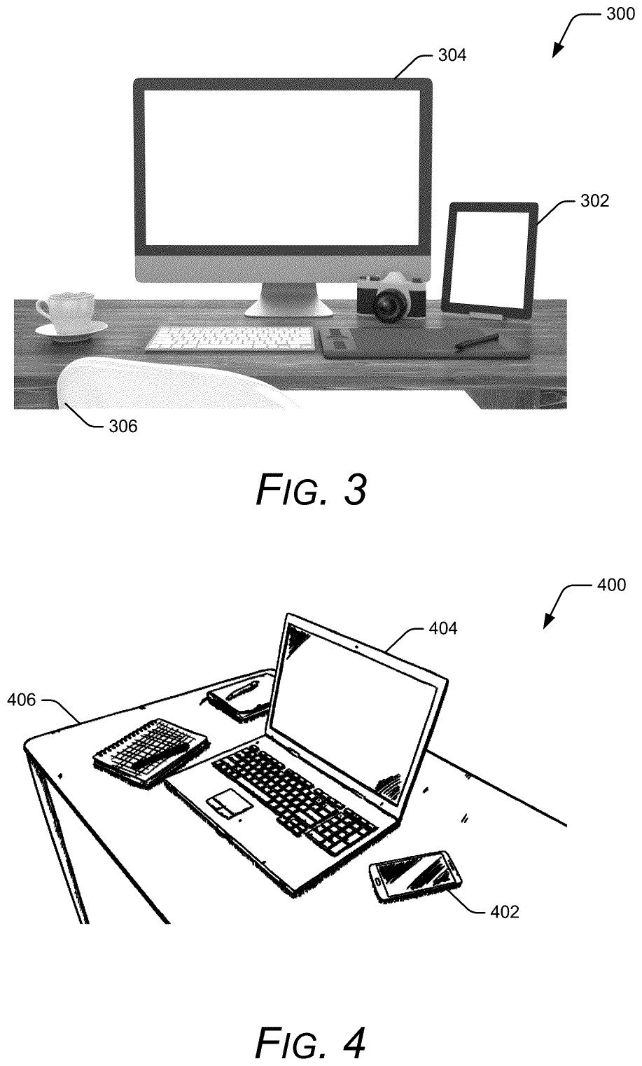

FIG. 3 illustrates an example 300 of displays that are spatially aligned. In the example 300, displays of two electronic devices are illustrated as display 302 (e.g., of a tablet) and display 304 (e.g., of a desktop computer). As illustrated the displays 302 and 304 are both approximately vertical and thus are spatially aligned.

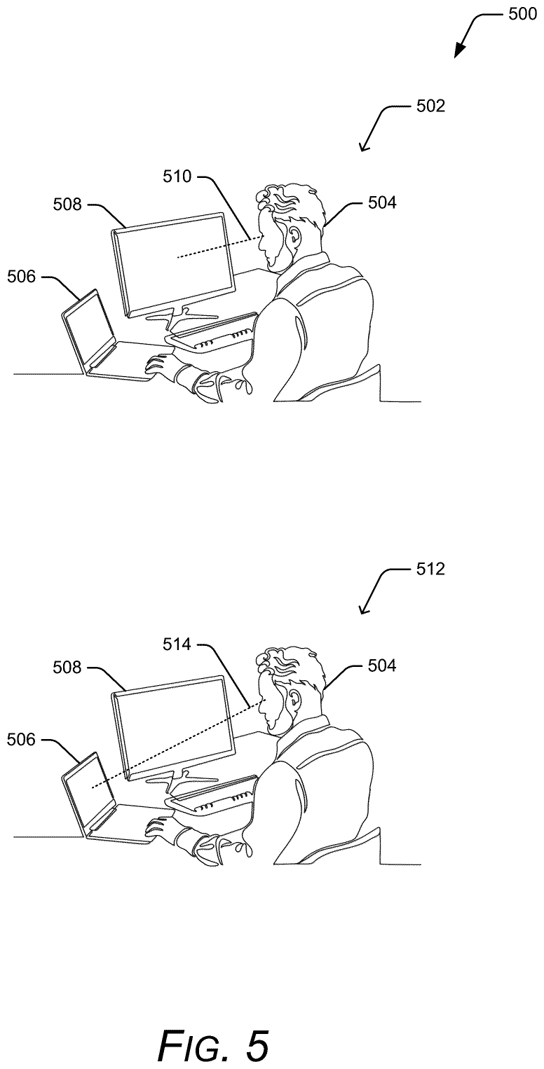

FIG. 4 illustrates an example 400 of displays that are not spatially aligned. In the example 400, displays of two electronic devices are illustrated as display 402 (e.g., of a smartphone) and display 404 (e.g., of a laptop computer). As illustrated, the display 404 is approximately vertical whereas the display 402 is approximately horizontal. Accordingly, the displays 402 and 404 are not spatially aligned.

Returning to FIG. 2, in one or more implementations the spatial alignment determination system 122 determines whether the two displays are positioned at approximately the same angle relative to a surface using other techniques. For example, the spatial alignment determination system 122 determines whether the two displays are positioned at approximately the same angle relative to a surface based on a position of the head of the user (e.g., an angle of the user's head relative to a surface). For example, the spatial alignment determination system 122 determines a position of the head of the user of the electronic device 102 (e.g., an angle of the user's face relative to the display of the electronic device 102 as indicated by images captured by the image capture module 120) and also receives an indication from the electronic device 104 of a position of the head of the user of the electronic device 104 (e.g., an angle of the user's face relative to the display of the electronic device 104 as indicated by images captured by an image capture module of the electronic device 104). If the position of the head of the user as determined by the spatial alignment determination system 122 is approximately the same (e.g., within 5 or 10 degrees) as the position of the head indicated in the indication received from the electronic device 104, then the spatial alignment determination system 122 determines whether the two displays are positioned at approximately the same angle relative to a surface.

The spatial alignment determination system 122 determines whether two displays are facing approximately the same direction in any of a variety of different manners. In one or more implementations, the spatial alignment determination system 122 analyzes the gaze of a user of the electronic device 102 and determines, based on the gaze, whether the user is looking at the display of the electronic device 102. The gaze of the user refers to where the user is looking, such as direction his or her pupils are facing. The gaze of the user is captured by an image capture module of the electronic device 102, such as image capture module 120 of FIG. 1. Any of a variety of public or proprietary techniques can be used to analyze the user's pupils to determine an angle, relative to the image capture module 120, at which the pupils are positioned and thus whether the user is looking at the display of the electronic device 102.

Similarly, the electronic device 104 similarly analyzes the gaze of a user of the electronic device 104 (e.g., using a system analogous to the spatial alignment determination system 122) and determines, based on the gaze, whether the user is looking at the display of the electronic device 104. The electronic device 104 transmits to the electronic device 102 (e.g., to the spatial alignment determination system 122) an indication of whether the user is looking at the display of the electronic device 104 analogous to the discussion above regarding spatial alignment determination system 122.

The spatial alignment determination system 122 determines whether the displays of the electronic devices 102 and 104 are facing approximately the same direction based on the determination of whether the user is looking at the display of the electronic device 102 and the indication received from the electronic device 104 of whether the user is looking at the display of the electronic device 104. For example, if the user is looking at the display of the electronic device 102 and the indication received from the electronic device 104 indicates the user is looking at the display of the electronic device 104, then the spatial alignment determination system 122 determines that the displays of the electronic devices 102 and 104 are facing approximately the same direction. However, if the user is not looking at the display of the electronic device 102 or the indication received from the electronic device 104 indicates the user is not looking at the display of the electronic device 104, then the spatial alignment determination system 122 determines that the displays of the electronic devices 102 and 104 are not facing approximately the same direction.

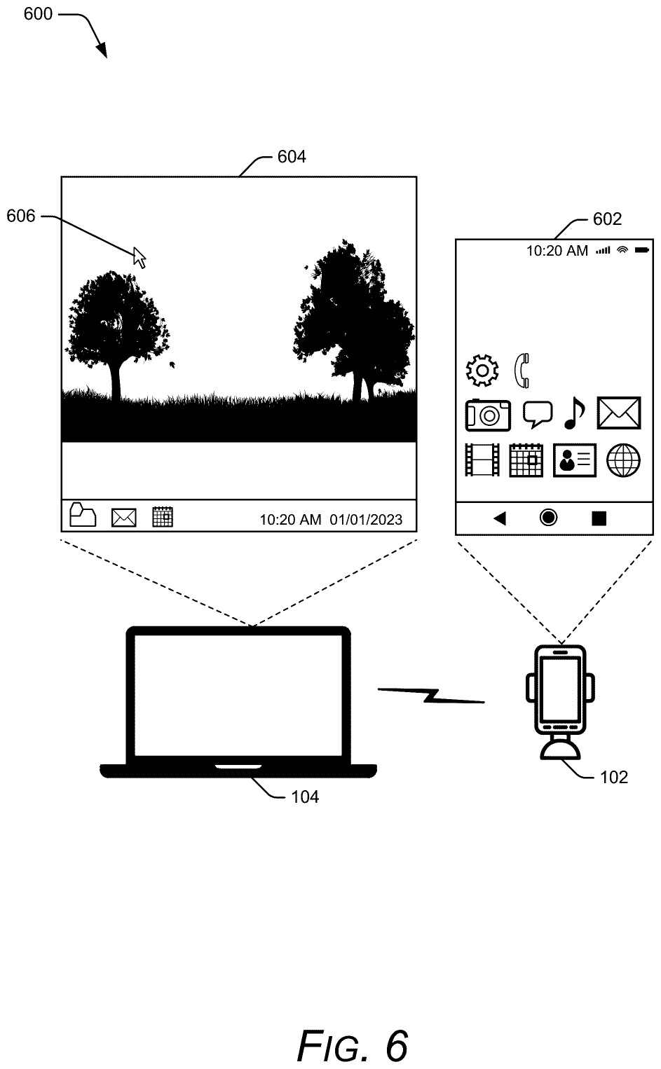

FIG. 5 illustrates an example 500 of the gaze of a user. At 502, a user 504 having two electronic devices 506 and 508 is illustrated. A dashed line 510 illustrates the gaze of the user 504 at 502, with the user looking at (gazing at) the electronic device 508.

At 512, the user 504 having the two electronic devices 506 and 508 is illustrated. A dashed line 514 illustrates the gaze of the user 504 at 512, with the user looking at (gazing at) the electronic device 506.

Returning to FIG. 2, additionally or alternatively, an image capture module of the electronic device 104 captures images of the user and transmits those images to the spatial alignment determination system 122. The spatial alignment determination system 122 uses the images received from the electronic device 104 to determine whether the user is looking at the display of the electronic device 104. Accordingly, the electronic device 104 need not include a system capable of determining whether the user is looking at the display of the electronic device 104.

Additionally or alternatively, the spatial alignment determination system 122 uses different techniques (e.g., other than using the gaze of a user) to determine whether two displays are facing approximately the same direction. For example, the spatial alignment determination system 122 can analyze images captured by the image capture module 120 as well as images received from the electronic device 104 (e.g., captured by an image capture module of the electronic device 104) to determine whether the scenes in the images are approximately the same. If the scene in one or more images captured by the image capture module 120 and the scene in one or more images captured by the image capture module of the electronic device 104 are approximately the same, then the spatial alignment determination system 122 determines that the two displays are facing approximately the same direction. However, if the scene in one or more images captured by the image capture module 120 and the scene in one or more images captured by the image capture module of the electronic device 104 are not approximately the same then the spatial alignment determination system 122 determines that the two displays are facing approximately the same direction. Any of a variety of techniques can be used to determine whether two scenes are approximately the same, such as identification of common objects or persons in the scenes, light levels in the scenes, motion in the scenes, and so forth.

By way of example, images captured by an image capture module in the display 304 of FIG. 3 will capture scenes approximately similar to the scenes in images captured by an image capture module of the display 302, such as scenes including the chair 306, a wall or other objects (not shown) behind the chair 306, and so forth. By way of another example, images captured by an image capture module in the display 404 of FIG. 4 will capture scenes that are not approximately similar to the scenes in images captured by an image capture module of the display 402. E.g., scenes captured by an image capture module in the display 404 will include objects such as a chair, wall, or people (not shown) behind the desk 406, whereas scenes captured by an image capture module in the display 402 will include objects such as a ceiling, a light fixture or ceiling fan (not shown), and so forth above the desk 406.

Returning to FIG. 2, in one or more implementations, the spatial alignment determination system 122 determines whether the displays of the electronic devices 102 and 104 are spatially aligned and provides an indication of whether the displays of the electronic devices 102 and 104 are spatially aligned to the input control module 210 and to the electronic device 104. This allows the input control module 210 to enable or activate universal input control on the electronic device 102 and the input control module 208 to enable or activate universal input control on the electronic device 104.

Additionally or alternatively, the electronic device 104 includes a spatial alignment determination system, analogous to the spatial alignment determination system 122, that determines whether the displays of the electronic devices 102 and 104 are spatially aligned and provides an indication of whether the displays of the electronic devices 102 and 104 are spatially aligned to the input control module 208 and to the electronic device 102. This allows the input control module 208 to enable or activate universal input control on the electronic device 104 and the input control module 210 to enable or activate universal input control on the electronic device 102.

It should be noted that the displays of two electronic devices can be spatially aligned even if other portions of the electronic devices are not spatially aligned. For example, an electronic device may be laying down or placed vertically (e.g., a desktop computer, the housing or keyboard of a laptop computer) while the display of the electronic device is positioned at a different angle. E.g., in the example 300 of FIG. 3, a desktop computer (not shown) may be providing content for display on the display 304. The display 302 is spatially aligned with the display 304 even if the display 302 is not spatially aligned with other portions or surfaces of the desktop computer providing content for display on the display 304.

Whether the displays of two electronic devices are spatially aligned is determined in response to any one or more of a variety of different events. One example of such an event is detecting that the electronic device 102 and the electronic device 104 are connected to one another. Another example of such an event is movement of one or both of the electronic device 102 or the electronic device 104 (e.g., based on accelerometer or gyrometer in the electronic device 102 or electronic device 104).

Add comment that spatial alignment is checked at regular or irregular intervals (e.g., in response to movement of the electronic device 102 or the electronic device 104). Universal input control is disabled or deactivated in response to the electronic devices 102 and 104 no longer being connected or in response to the displays of the electronic devices 102 and 104 no longer being spatially aligned.

E.g., whether the displays of two electronic devices are spatially aligned may be determined in response to detecting that the two electronic devices are connected to one another. This determination of whether the displays are spatially aligned is maintained and used by the electronic devices 102 and 104 (e.g., to enable universal input control) until movement of one or both of the electronic devices is detected. In response to such detected movement, whether the displays of two electronic devices are spatially aligned is again determined (e.g., after the movement has stopped, such as stopped for a threshold amount of time (e.g., 2 or 3 seconds)). This new determination of whether the displays are spatially aligned is maintained and used by the electronic devices 102 and 104 (e.g., to enable universal input control) until movement of one or both of the electronic devices is again detected.

When universal input control is enabled or activated, the electronic device 104 receives user input via the input control device 202. This user input can take various forms, such as movement of a cursor or pointer, selection of a button or switch, selection of a pull-down menu, and so forth. The input control module 208 receives this user input and performs whatever action is indicated by the user input, such as moving a pointer or cursor, activating, or selecting a button that is clicked on, and so forth, or provides an indication of the user input to an input control module 210 of the electronic device 104. This indication of the user input can include various information, such as a direction of movement of the input control device 202, an amount or length of movement of the input control device 202, user activation of a button (e.g., a mouse click), and so forth. The input control module 208 performs whatever action is indicated by the received indication, such as moving a pointer or cursor, activating, or selecting a button that is clicked on, and so forth.

Whether the input control module 208 performs the action indicated by the user input or provides an indication of the user input to the input control module 210 depends on the user input and a current location of a pointer or cursor. The input control module 208 knows the dimensions of a display of the electronic device 104 and keeps track of the current location of the pointer or cursor on the display of the electronic device 104. The input control module 208 also knows the location of the electronic device 102 relative to the electronic device 104 (e.g., whether the electronic device 102 is to the left of the electronic device 104, the electronic device 102 is to the right of the electronic device 104, and so forth). The input control module 208 can determine the location of the electronic device 102 relative to the electronic device 104 in any of a variety of manners, such as by receiving a user input indicating the location, by accessing a configuration setting of the electronic device 104 or the electronic device 102 (e.g., which may be set by a user of the electronic device 104 or the electronic device 102, by a system administrator of the electronic device 102 or the electronic device 102, by a developer or distributor of the electronic device 104 or the 102, and so forth), by analyzing signals received from the electronic device 102 (e.g., if sensors or microphones are on the left and right side of the electronic device 104, which sensors or microphones receive a signal or audio from the electronic device 102 first), by analyzing a gaze of a user of the electronic devices 102 and 104, and so forth.

The electronic device 102 can similarly determine the location of the electronic device 104 relative to the electronic device 102 in various manners analogous to the discussion above regarding the electronic device 104 determining the location of the electronic device 102 relative to the electronic device 104. Additionally or alternatively, the electronic device 102 may receive an indication of the location of the electronic device 102 relative to the electronic device 104 as determined by the electronic device 104. Additionally or alternatively, the electronic device 104 may receive an indication of the location of the electronic device 104 relative to the electronic device 102 as determined by the electronic device 102.

If user input would result in moving the pointer or cursor off the display on the electronic device 104 in the direction of the electronic device 102, the input control module 208 stops displaying the pointer or cursor on the display of the electronic device 104 and also provides the indication of the user input to the input control module 210 so that the input control module 210 can display and move the pointer or cursor appropriately on the display of the electronic device 102, or select the appropriate button on the display of the electronic device 102. Similarly, if the user input then moves the pointer or cursor off the display on electronic device 102 in the direction of the electronic device 104, the input control module 210 stops displaying the cursor or pointer on the display of the electronic device 102, the input control module 208 stops providing the indication of the user input to the input control module 210 and the input control module 208 displays and moves the pointer or cursor appropriately, or selects the appropriate button, on the display of the electronic device 104.

In one or more implementations, the input control module 208 displays an indication of which side (e.g., left, right, top, or bottom) of the electronic device 104 the electronic device 102 is positioned (e.g., where the electronic device 104 is positioned relative to the electronic device 102). The displayed indication can take various forms, such as a rectangular box along the entire edge of the display of the electronic device 104 with a particular fill or color (e.g., a green box), a rectangular box along a portion of the edge of the display of the electronic device 104 with a particular fill or color (e.g., a green box), changing the manner in which the pointer or cursor is displayed (e.g., changing the color of the pointer or cursor), and so forth.

The input control module 208 can display the indication when the user input is close to moving the pointer or cursor off the display of the electronic device 104 and onto the display of the electronic device 102. This closeness can be determined in various manners, such as the pointer or cursor being within a threshold distance (e.g., a threshold number of pixels) of the edge of the display of the electronic device 104. Additionally or alternatively, the input control module 208 displays the indication regardless of how close the user input is to moving the pointer or cursor off the display of the electronic device 104 and onto the display of the electronic device 102.

In one or more implementations, the input control module 210 displays an indication of which side (e.g., left, right, top, or bottom) of the electronic device 102 the electronic device 104 is positioned (e.g., where the electronic device 102 is positioned relative to the electronic device 104). The displayed indication can take various forms, such as a rectangular box along the entire edge of the display of the electronic device 102 with a particular fill or color (e.g., a green box), a rectangular box along a portion of the edge of the display of the electronic device 102 with a particular fill or color (e.g., a green box), changing the manner in which the pointer or cursor is displayed (e.g., changing the color of the pointer or cursor), and so forth. The input control module 210 can display the indication when the user input is close to moving the pointer or cursor off the display of the electronic device 102 and onto the display of the electronic device 104. This closeness can be determined in various manners, such as the pointer or cursor being within a threshold distance (e.g., a threshold number of pixels) of the edge of the display of the electronic device 102. Additionally or alternatively, the input control module 208 displays the indication regardless of how close the user input is to moving the pointer or cursor off the display of the electronic device 104 and onto the display of the electronic device 102.

It should be noted that in some situations the height or width of the display of the electronic device 104 may be different than the height or width of the display of the electronic device 102. In such situations, various techniques can be used when the user input moves the pointer or cursor from one display to the other. For example, if the height of the display of the electronic device 104 is larger than the height of the display of the electronic device 102 and the cursor is at the top of the display of the electronic device 104, then the pointer or cursor may be moved to the top of the display of the electronic device 102. By way of another example, if the height of the display of the electronic device 104 is larger than the height of the display of the electronic device 102 and the cursor is at the top of the display of the electronic device 104, then the pointer or cursor may not be moved to the display of the electronic device 102 until further user input moves the pointer or cursor down to the height of the top of the display of the electronic device 102.

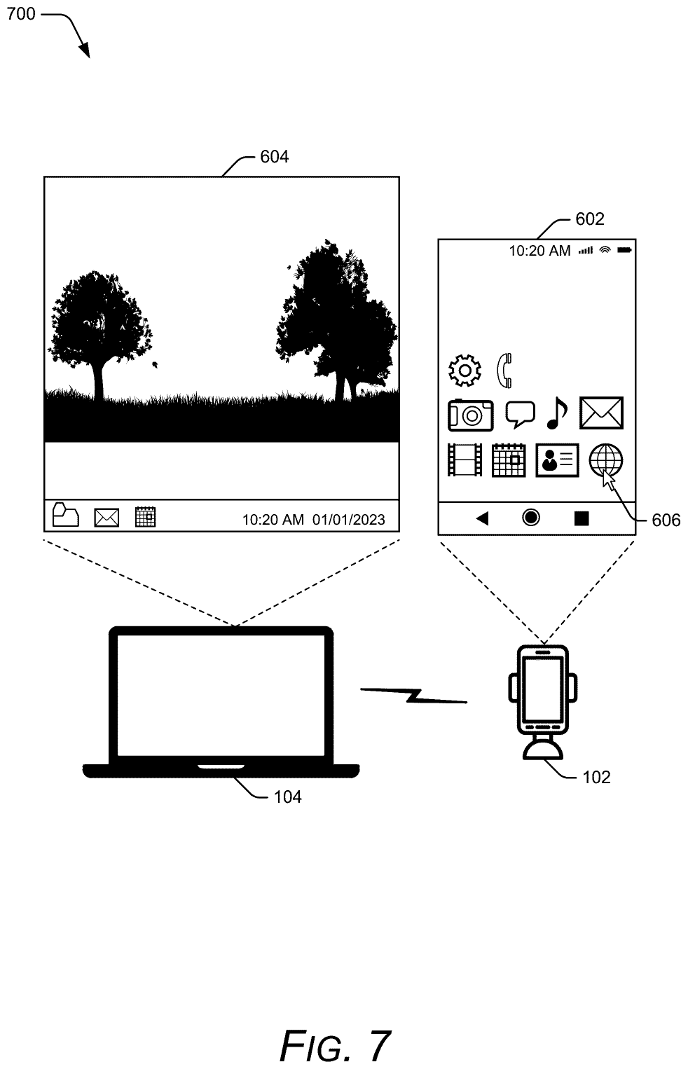

FIGS. 6, 7, 8, and 9 illustrate examples of using the techniques discussed herein. It is to be appreciated that these are only examples and that the electronic devices can be at any location relative to each other (e.g., the electronic device 102 can be to the left, to the right, above, or below the electronic device 104, the electronic device 102 can be diagonal from the electronic device 104 (e.g., upper right, lower left), and so forth). Furthermore, specific examples of electronic devices are illustrated, such as a laptop computer, a smartphone, or a tablet. It is to be appreciated that these are only examples and that the electronic devices can be any of a variety of electronic devices as discussed above.

FIG. 6 illustrates an example 600 of using the techniques discussed herein. The example 600 includes the electronic device 102 (illustrated as a smartphone in a holder or stand) and the electronic device 104 (illustrated as a laptop computer). In the example 600, the electronic device 102 is to the right of the electronic device 104. The electronic device 102 displays on its display a user interface 602 including multiple icons that can be selected to perform various operations or run various applications (e.g., a phone icon selectable to launch a phone application, a music icon selectable to launch a music playback application). The electronic device 104 displays on its display a user interface 604 including a background image (e.g., wallpaper) of trees and grass, and a toolbar including multiple icons that can be selected to perform various operations or run various applications (e.g., an envelope icon selectable to launch an email application, a calendar icon selectable to launch a calendar application). The toolbar also includes additional information such as a current time (e.g., 10:20 AM) and a current date (e.g., Jan. 1, 2023). The user interface 604 also includes a pointer 606 that is controlled by an input control device of the electronic device 104 (e.g., a trackpad that is part of the electronic device 104).

In the example 600, the user input via the input control device of the electronic device 104 has resulted in the pointer 606 being located on the display of the electronic device 104. Accordingly, no pointer is displayed on the display of the electronic device 102.

As illustrated in the example 600, different user interfaces are displayed by the electronic devices 102 and 104. The user interface displayed on the display of the electronic device 102 is different than the display of the electronic device 104 (e.g., the user interface displayed on the display of the electronic device 102 is not mirrored on the display of the electronic device 104), the user interface displayed on the display of the electronic device 102 is not displayed within a window on the display of the electronic device 104, and so forth.

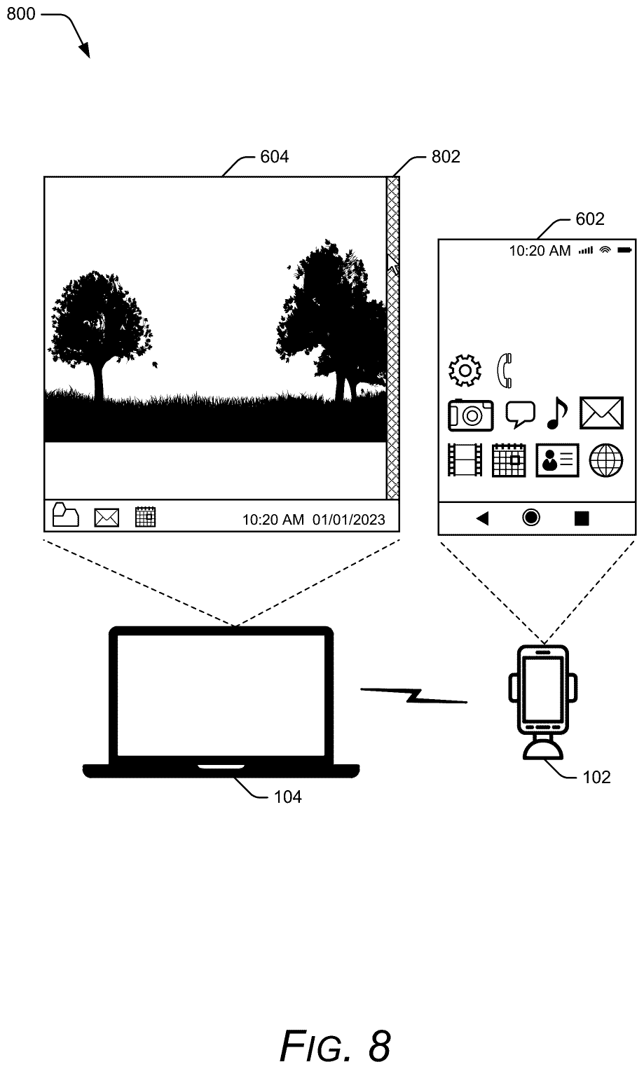

FIG. 7 illustrates an example 700 of using the techniques discussed herein. The example 700 includes the electronic device 102 (illustrated as a smartphone in a holder or stand) displaying the user interface 602 and the electronic device 104 (illustrated as a laptop computer) displaying the user interface 604. In the example 700, the electronic device 102 is to the right of the electronic device 104. The example 700 is analogous to the example 600 of FIG. 6, except that the user input via the input control device of the electronic device 104 has resulted in the pointer 606 being located on the display of the electronic device 102. Accordingly, no pointer is displayed on the display of the electronic device 104. It should be noted that the pointer 606, although displayed on the display of the electronic device 102, is controlled by the input control device of the electronic device 104 (e.g., a trackpad that is part of the electronic device 104).

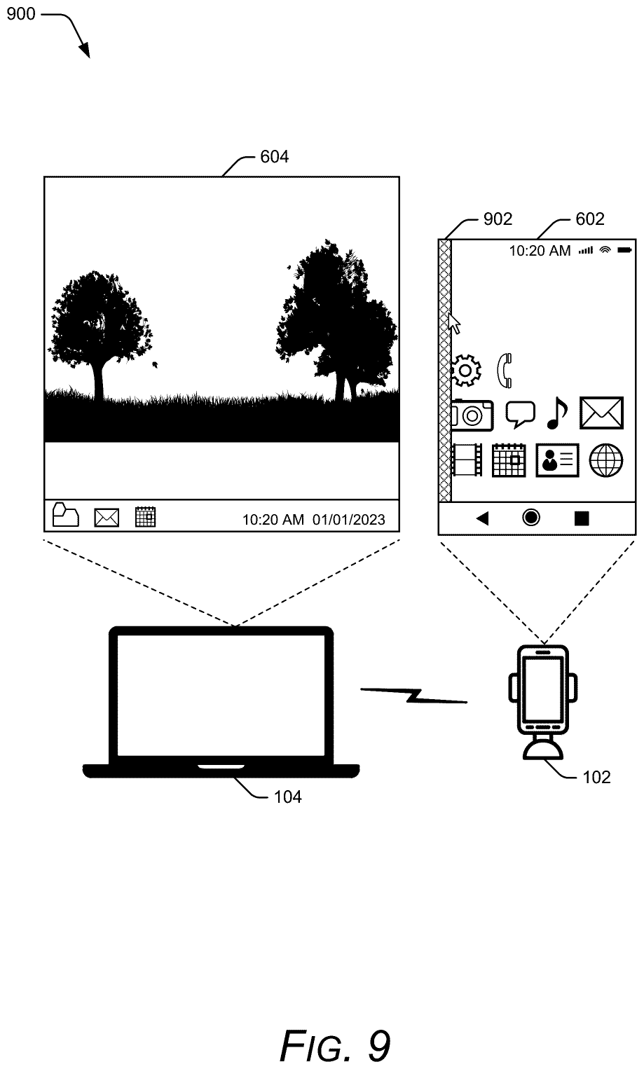

FIG. 8 illustrates an example 800 of using the techniques discussed herein. The example 800 includes the electronic device 102 (illustrated as a smartphone in a holder or stand) displaying the user interface 602 and the electronic device 104 (illustrated as a laptop computer) displaying the user interface 604. In the example 800, the electronic device 102 is to the right of the electronic device 104. The example 800 is analogous to the example 600 of FIG. 6, except that an indication 802 of the position of the electronic device 102 relative to the electronic device 104 is displayed on the display of the electronic device 104. The indication 802 in the example 800 is a bar along the right edge of the display of the electronic device 104, illustrated with cross hatching.

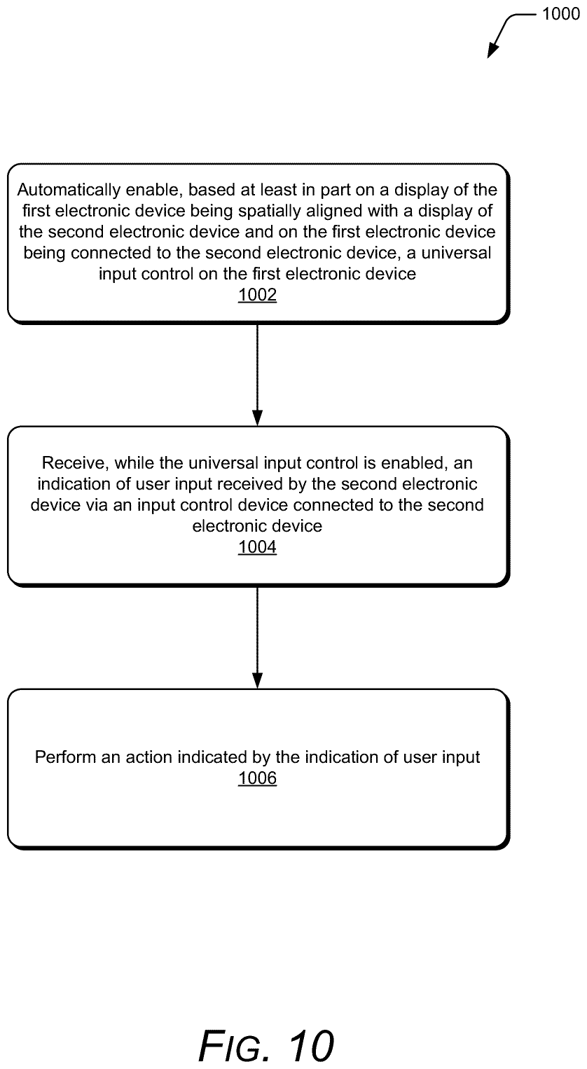

FIG. 9 illustrates an example 900 of using the techniques discussed herein. The example 900 includes the electronic device 102 (illustrated as a smartphone in a holder or stand) displaying the user interface 602 and the electronic device 104 (illustrated as a laptop computer) displaying the user interface 604. In the example 900, the electronic device 102 is to the right of the electronic device 104. The example 900 is analogous to the example 600 of FIG. 6, except that an indication 902 of the position of the electronic device 104 relative to the electronic device 102 is displayed on the display of the electronic device 102. The indication 902 in the example 900 is a bar along the left edge of the display of the electronic device 104, illustrated with cross hatching.

It should be noted that some discussions herein refer to two electronic devices. However, it is to be appreciated that one electronic device may be connected to multiple other devices, such as one to the right and one above, one to the right and one to the left, and so forth. The techniques discussed herein apply to situations where one or more electronic devices are connected to another electronic device. Whether the displays of any two electronic devices that are connected to one another (e.g., wirelessly or wired) are spatially aligned can be determined using the techniques discussed herein.

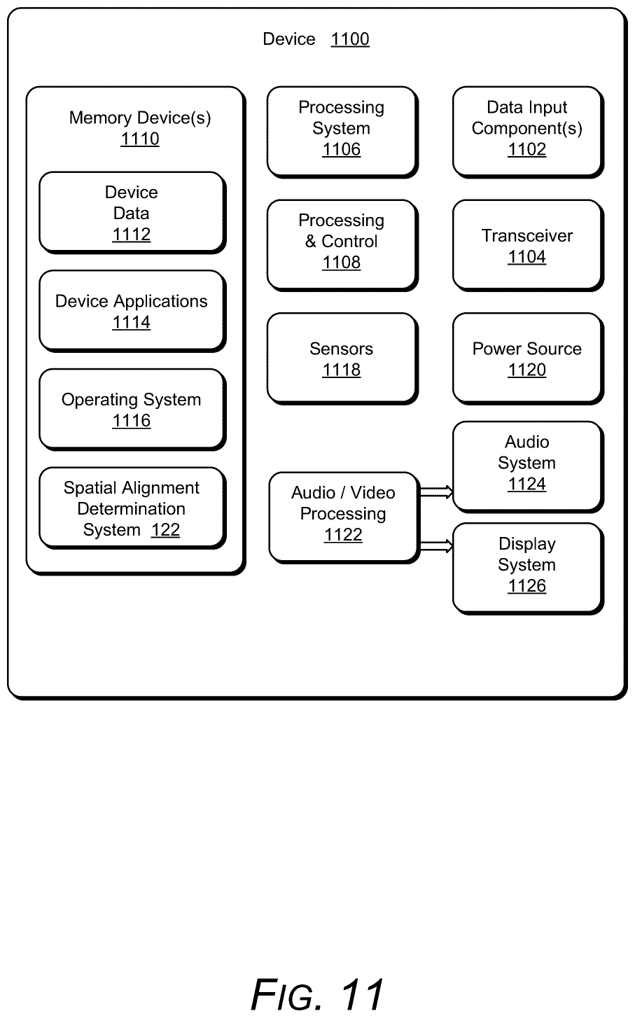

FIG. 10 illustrates an example process 1000 for implementing the techniques discussed herein in accordance with one or more embodiments. Process 1000 is carried out at least in part by a device position determination system, such as spatial alignment determination system 122 of FIG. 1 or FIG. 2, and can be implemented in software, firmware, hardware, or combinations thereof. Process 1000 is shown as a set of acts and is not limited to the order shown for performing the operations of the various acts.

In process 1000, universal input control on a first electronic device is automatically enabled (act 1002). The universal input control is automatically enabled based at least in part on a display of the first electronic device being spatially aligned with a display of a second electronic device and on the first electronic device being connected to the second electronic device. As discussed above, this connection can be a wireless connection or a wired connection.

At the first electronic device, an indication of user input received by the second electronic device via an input control device connected to the second electronic device is received (act 1004). This indication is received while the universal input control is enabled.

An action indicated by the indication of user input is performed at the first electronic device (act 1006). This action can be, for example, movement of a pointer or cursor, selection of an object or button, and so forth.

FIG. 11 illustrates various components of an example electronic device in which embodiments of device input control based on spatial alignment of displays can be implemented. The electronic device 1100 can be implemented as any of the devices described with reference to the previous FIGs., such as any type of client device, mobile phone, tablet, computing, communication, entertainment, gaming, media electronic playback, or other type of electronic device. In one or more embodiments the device 1100 is an electronic device 102 or electronic device 104 and includes the spatial alignment determination system 122, described above.

The electronic device 1100 includes one or more data input components 1102 via which any type of data, media content, or inputs can be received such as user-selectable inputs, messages, music, television content, recorded video content, and any other type of text, audio, video, or image data received from any content or data source. The data input components 1102 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 1102 may also include various other input components such as microphones, touch sensors, touchscreens, keyboards, and so forth.

The device 1100 includes communication transceivers 1104 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 1100 includes a processing system 1106 of one or more processors (e.g., any of microprocessors, controllers, and the like) or a processor and memory system implemented as a system-on-chip (SoC) that processes computer-executable instructions. The processing system 1106 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1108. The device 1100 may further include any type of a system bus or other data and command transfer system that couples the various components within the device. A system bus can include any one or combination of different bus structures and architectures, as well as control and data lines.

The device 1100 also includes computer-readable storage memory devices 1110 that enable data storage, such as data storage devices that can be accessed by an electronic device, and that provide persistent storage of data and executable instructions (e.g., software applications, programs, functions, and the like stored thereon). Examples of the computer-readable storage memory devices 1110 include volatile memory and non-volatile memory, fixed and removable media devices, and any suitable memory device or electronic data storage that maintains data for electronic device access. The computer-readable storage memory can include various implementations of random access memory (RAM), read-only memory (ROM), flash memory, and other types of storage media in various memory device configurations. The device 1100 may also include a mass storage media device.

The computer-readable storage memory device 1110 provides data storage mechanisms to store the device data 1112, other types of information or data, and various device applications 1114 (e.g., software applications). For example, an operating system 1116 can be maintained as software instructions with a memory device and executed by the processing system 1106 to cause the processing system 1106 to perform various operations or actions. The device applications 1114 may also include a device manager, such as any form of a control application, software application, signal-processing and control module, code that is native to a particular device, a hardware abstraction layer for a particular device, and so on.

The device 1100 can also include one or more device sensors 1118, such as any one or more of an ambient light sensor, a proximity sensor, a touch sensor, an infrared (IR) sensor, an accelerometer, a gyroscope, a magnetometer, a thermal sensor, an audio sensor (e.g., microphone), and the like. The device 1100 can also include one or more power sources 1120, such as when the device 1100 is implemented as a computing device. The power sources 1120 may include a charging or power system, and can be implemented as a flexible strip battery, a rechargeable battery, a charged super-capacitor, or any other type of active or passive power source.

The device 1100 additionally includes an audio or video processing system 1122 that generates one or both of audio data for an audio system 1124 and display data for a display system 1126. In accordance with some embodiments, the audio/video processing system 1122 is configured to receive call audio data from the transceiver 1104 and communicate the call audio data to the audio system 1124 for playback at the device 1100. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

Although embodiments of techniques for device input control based on spatial alignment of displays have been described in language specific to features or methods, the subject of the appended claims is not necessarily limited to the specific features or methods described. Rather, the specific features and methods are disclosed as example implementations of techniques for implementing device input control based on spatial alignment of displays. Further, various different embodiments are described, and it is to be appreciated that each described embodiment can be implemented independently or in connection with one or more other described embodiments. Additional aspects of the techniques, features, and/or methods discussed herein relate to one or more of the following.

In some aspects, the techniques described herein relate to a method, implemented in a first electronic device, the method including: automatically enabling, based at least in part on a display of the first electronic device being spatially aligned with a display of a second electronic device and on the first electronic device being connected to the second electronic device, a universal input control on the first electronic device; receiving, while the universal input control is enabled, an indication of user input received by the second electronic device via an input control device connected to the second electronic device; and performing an action indicated by the indication of user input.

In some aspects, the techniques described herein relate to a method, further including communicating, to the second electronic device, that universal input control for the first electronic device and the second electronic device has been enabled.

In some aspects, the techniques described herein relate to a method, further including determining that the display of the first electronic device is spatially aligned with the display of the second electronic device in response to both the display of the first electronic device and the display of the second electronic device being positioned approximately vertically, and both the display of the first electronic device and the display of the second electronic device facing a same direction.

In some aspects, the techniques described herein relate to a method, further including determining that the display of the first electronic device is spatially aligned with the display of the second electronic device in response to both the display of the first electronic device and the display of the second electronic device being positioned approximately horizontally, and both the display of the first electronic device and the display of the second electronic device facing a same direction.

In some aspects, the techniques described herein relate to a method, further including determining that the display of the first electronic device is spatially aligned with the display of the second electronic device in response to the display of the first electronic device being positioned at an angle within a threshold number of degrees of an angle at which the display of the second electronic device is positioned, and both the display of the first electronic device and the display of the second electronic device facing a same direction.

In some aspects, the techniques described herein relate to a method, further including disabling, based at least in part on the display of the first electronic device no longer being spatially aligned with the display of the second electronic device, the universal input control.

In some aspects, the techniques described herein relate to a method, further including disabling, based at least in part on the first electronic device no longer being connected to the second electronic device, the universal input control.

In some aspects, the techniques described herein relate to a method, wherein the first electronic device includes a mobile phone and the second electronic device includes a laptop computer.

In some aspects, the techniques described herein relate to a method, wherein the input control device includes a pointer control device.

In some aspects, the techniques described herein relate to a method, wherein a user interface displayed on the first electronic device is different than a user interface displayed on the second electronic device, and the user interface displayed on the first electronic device is not displayed on the second electronic device.

In some aspects, the techniques described herein relate to a first electronic device, including: a processor implemented in hardware; and a computer-readable storage memory having stored thereon multiple instructions that, responsive to execution by the processor, cause the processor to: automatically activate, based at least in part on a display of the first electronic device being spatially aligned with a display of a second electronic device and on the first electronic device being connected to the second electronic device, a universal input control on the first electronic device; receive, while the universal input control is enabled, an indication of user input received by the second electronic device via an input control device connected to the second electronic device; and perform an action indicated by the indication of user input.

In some aspects, the techniques described herein relate to a first electronic device, wherein the multiple instructions cause the processor to communicate, to the second electronic device, that universal input control for the first electronic device and the second electronic device has been enabled.

In some aspects, the techniques described herein relate to a first electronic device, wherein the multiple instructions cause the processor to determine that the display of the first electronic device is spatially aligned with the display of the second electronic device in response to both the display of the first electronic device and the display of the second electronic device being positioned approximately vertically, and both the display of the first electronic device and the display of the second electronic device facing a same direction.

In some aspects, the techniques described herein relate to a first electronic device, wherein the multiple instructions cause the processor to determine that the display of the first electronic device is spatially aligned with the display of the second electronic device in response to both the display of the first electronic device and the display of the second electronic device being positioned approximately horizontally, and both the display of the first electronic device and the display of the second electronic device facing a same direction.

In some aspects, the techniques described herein relate to a first electronic device, wherein the multiple instructions cause the processor to determine that the display of the first electronic device is spatially aligned with the display of the second electronic device in response to the display of the first electronic device being positioned at an angle within a threshold number of degrees of an angle at which the display of the second electronic device is positioned, and both the display of the first electronic device and the display of the second electronic device facing a same direction.

In some aspects, the techniques described herein relate to a first electronic device, including: a display; a spatial alignment determination system, implemented at least in part in hardware, configured to automatically enable, based at least in part on a display of the first electronic device being spatially aligned with a display of a second electronic device and on the first electronic device being connected to the second electronic device, a universal input control on the first electronic device; and an input control module, implemented at least in part in hardware, configured to receive, while the universal input control is enabled, an indication of user input received by the second electronic device via an input control device connected to the second electronic device, and perform an action indicated by the indication of user input.

In some aspects, the techniques described herein relate to a first electronic device, wherein the spatial alignment determination system is configured to disable, based at least in part on the display of the first electronic device no longer being spatially aligned with the display of the second electronic device, the universal input control.

In some aspects, the techniques described herein relate to a first electronic device, wherein the spatial alignment determination system is configured to disable, based at least in part on the first electronic device no longer being connected to the second electronic device, the universal input control.

In some aspects, the techniques described herein relate to a first electronic device, wherein the first electronic device includes a mobile phone and the second electronic device includes a laptop computer.

In some aspects, the techniques described herein relate to a first electronic device, wherein a user interface displayed on the first electronic device is different than a user interface displayed on the second electronic device, and the user interface displayed on the first electronic device is not displayed on the second electronic device.

What is claimed is:

1. A method, implemented in a first electronic device, the method comprising:
automatically enabling, based at least in part on a display of the first electronic device being spatially aligned with a display of a second electronic device and on the first electronic device being connected to the second electronic device, a universal input control on the first electronic device;
receiving, while the universal input control is enabled, an indication of user input received by the second electronic device via an input control device connected to the second electronic device; and
performing an action indicated by the indication of user input.

2. The method of claim 1, further comprising communicating, to the second electronic device, that universal input control for the first electronic device and the second electronic device has been enabled.

3. The method of claim 1, further comprising determining that the display of the first electronic device is spatially aligned with the display of the second electronic device in response to both the display of the first electronic device and the display of the second electronic device being positioned approximately vertically, and both the display of the first electronic device and the display of the second electronic device facing a same direction.

4. The method of claim 1, further comprising determining that the display of the first electronic device is spatially aligned with the display of the second electronic device in response to both the display of the first electronic device and the display of the second electronic device being positioned approximately horizontally, and both the display of the first electronic device and the display of the second electronic device facing a same direction.

5. The method of claim 1, further comprising determining that the display of the first electronic device is spatially aligned with the display of the second electronic device in response to the display of the first electronic device being positioned at an angle within a threshold number of degrees of an angle at which the display of the second electronic device is positioned, and both the display of the first electronic device and the display of the second electronic device facing a same direction.

6. The method of claim 1, further comprising disabling, based at least in part on the display of the first electronic device no longer being spatially aligned with the display of the second electronic device, the universal input control.

7. The method of claim 1, further comprising disabling, based at least in part on the first electronic device no longer being connected to the second electronic device, the universal input control.

8. The method of claim 1, wherein the first electronic device comprises a mobile phone and the second electronic device comprises a laptop computer.

9. The method of claim 1, wherein the input control device comprises a pointer control device.

10. The method of claim 1, wherein a user interface displayed on the first electronic device is different than a user interface displayed on the second electronic device, and the user interface displayed on the first electronic device is not displayed on the second electronic device.

11. A first electronic device, comprising:
a processor implemented in hardware; and
a computer-readable storage memory having stored thereon multiple instructions that, responsive to execution by the processor, cause the processor to:
automatically activate, based at least in part on a display of the first electronic device being spatially aligned with a display of a second electronic device and on the first electronic device being connected to the second electronic device, a universal input control on the first electronic device;
receive, while the universal input control is enabled, an indication of user input received by the second electronic device via an input control device connected to the second electronic device; and
perform an action indicated by the indication of user input.

12. The first electronic device of claim 11, wherein the multiple instructions cause the processor to communicate, to the second electronic device, that universal input control for the first electronic device and the second electronic device has been enabled.

13. The first electronic device of claim 11, wherein the multiple instructions cause the processor to determine that the display of the first electronic device is spatially aligned with the display of the second electronic device in response to both the display of the first electronic device and the display of the second electronic device being positioned approximately vertically, and both the display of the first electronic device and the display of the second electronic device facing a same direction.

14. The first electronic device of claim 11, wherein the multiple instructions cause the processor to determine that the display of the first electronic device is spatially aligned with the display of the second electronic device in response to both the display of the first electronic device and the display of the second electronic device being positioned approximately horizontally, and both the display of the first electronic device and the display of the second electronic device facing a same direction.

15. The first electronic device of claim 11, wherein the multiple instructions cause the processor to determine that the display of the first electronic device is spatially aligned with the display of the second electronic device in response to the display of the first electronic device being positioned at an angle within a threshold number of degrees of an angle at which the display of the second electronic device is positioned, and both the display of the first electronic device and the display of the second electronic device facing a same direction.

16. A first electronic device, comprising:
a display;
a spatial alignment determination system, implemented at least in part in hardware, configured to automatically enable, based at least in part on a display of the first electronic device being spatially aligned with a display of a second electronic device and on the first electronic device being connected to the second electronic device, a universal input control on the first electronic device; and
an input control module, implemented at least in part in hardware, configured to receive, while the universal input control is enabled, an indication of user input received by the second electronic device via an input control device connected to the second electronic device, and perform an action indicated by the indication of user input.

17. The first electronic device of claim 16, wherein the spatial alignment determination system is configured to disable, based at least in part on the display of the first electronic device no longer being spatially aligned with the display of the second electronic device, the universal input control.

18. The first electronic device of claim 16, wherein the spatial alignment determination system is configured to disable, based at least in part on the first electronic device no longer being connected to the second electronic device, the universal input control.

19. The first electronic device of claim 16, wherein the first electronic device comprises a mobile phone and the second electronic device comprises a laptop computer.

20. The first electronic device of claim 16, wherein a user interface displayed on the first electronic device is different than a user interface displayed on the second electronic device, and the user interface displayed on the first electronic device is not displayed on the second electronic device.
